(19) United States
(12) Patent Application Publication
(10) Pub. No.: US 2011/0012003 A1
(43) Pub. Date: Jan. 20, 2011

(54) APPARATUS AND METHODS FOR PROVIDING A RETRACTIBLE MAST

(75) Inventors: Christopher D. WOODRUFF, Palmetto, FL (US); Kevin GROAH, Mims, FL (US); George E. WOODRUFF, Titusville, FL (US)

Correspondence Address: LOWE HAUPTMAN HAM & BERNER, LLP, 1700 DIAGONAL ROAD, SUITE 300, ALEXANDRIA, VA, 22314, US

(73) Assignee: GEO SYSTEMS, INC., Titusville, FL (US)

(21) Appl. No.: 12/883,672

(22) Filed: Sep. 16, 2010

Related U.S. Application Data
(63) Continuation-in-part of application No. 11/406,500, filed on Apr. 19, 2006, now abandoned.
(60) Provisional application No. 60/674,345, filed on Apr. 19, 2005.
(60) Provisional application No. 60/674,346, filed on Apr. 19, 2005.
(60) Provisional application No. 60/755,054, filed on Dec. 30, 2005.

(51) Int. Cl. F16M 11/40; B23K 26/38; B21D 53/00

(52) U.S. Cl. 248/404; 219/121.72; 72/128

(57) ABSTRACT

Apparatus and methods for raising a retractable mast include engaging at least three flexible bands such that each band forms a side of a mast. Each band includes a right edge side and a left edge side, each edge having disposed thereon a set of spaced teeth, each tooth having a slot disposed therein and a tab disposed between adjacent teeth, the tab configured to engage the slot of an opposing tooth.

### RELATED APPLICATIONS

The present application is a continuation-in-part of, and claims priority from: U.S. application Ser. No. 11/406,500, filed Apr. 19, 2010 which, in turn, claims priority from U.S. Provisional application No. 60/674,345 entitled “Autonomous or Controlled Robot for Undervehicle Inspection” filed Apr. 19, 2005; U.S. Provisional application No. 60/674,346 entitled “Sensor/Camera Back Pack Lift” filed Apr. 19, 2005; and U.S. Provisional application No. 60/755,054 entitled “Zipper Mast Lift” filed Dec. 30, 2005, assigned to the assignee hereof. All of the above-listed applications are hereby expressly incorporated by reference herein.

### TECHNICAL FIELD

The disclosed embodiments relate to lift mechanisms, and more particularly, to apparatus and methods for forming a retractable rigid mast.

Lift mechanism technology includes, but is not limited to, hydraulic, pneumatic, and link type structures that may be combined together to form a rigid structure.

### BACKGROUND

Extendable masts have seen applications in both the commercial and military markets. For example, electronic packages mounted atop retractable masts include communication and sensor devices, i.e., antennas, cameras and microphones, for collecting sensory data and/or transmitting the collected data to a remote location.

As the deployment of mobile surveillance and communication systems increases, a lightweight, portable, mobile, and reliable retractable platform support systems may be desirable.

### SUMMARY

According to at least one embodiment, a method for raising a retractable mast includes drawing together at least three flexible bands from a housing, such that the bands engage to foam a rigid mast. Each band comprises a first edge portion, a second edge portion and a body therebetween, whereby tabs, slots, or teeth, disposed along opposite edges of each of the at least three flexible bands engage correspond tabs, slots, or teeth, disposed on the edge portions of adjacent flexible bands.

According to at least one embodiment, the housing further comprises a feed mechanism operable to interlock the at least three lengths of flexible bands by drawing the at least three band together causing interlocking mechanisms on opposing horizontal edges of each of the at least three flexible bands to engage a mating mechanism of an adjacent flexible band.

### BRIEF DESCRIPTION OF THE DRAWINGS

The disclosed embodiments will hereinafter be described in conjunction with the appended drawings provided to illustrate and not to limit the disclosed embodiments, wherein like designations denote like elements, and in which:

FIG. 1 is a perspective drawing of a lift mechanism forming a retractable mast from a set of flexible bands;

FIG. 2 is a view taken along lines 2-2 of FIG. 1;

FIG. 3 is a plan view of a portion of one embodiment of the flexible band according to FIG. 1;

FIG. 4 is a plan view of a portion of another embodiment of the flexible band according to FIG. 1;

FIG. 5 is partial side view of two adjacent flexible bands interlocking to form the retractable mast of FIG. 1;

FIG. 6 is a block diagram of the lift mechanism according to FIG. 1;

FIG. 7A and 7B are perspective drawings of components of a cable management system according to FIG. 1;

FIG. 8 is a perspective drawing of one embodiment of a weather shield for protecting the lift mechanism of FIG. 1;

FIG. 9 is an environmental drawing of one embodiment of a backpack incorporating the lift mechanism of FIG. 1.

FIG. 10 is an embodiment of a robotic device incorporating the lift mechanism of FIG. 1;

FIG. 11 is a block diagram of the robotic device according to FIG. 10;

FIG. 12A is a perspective drawing of one embodiment of a suitcase incorporating the lift mechanism incorporating the lift mechanism of FIG. 1;

FIG. 12B is a perspective drawing of another embodiment of a suitcase incorporating the lift mechanism incorporating the lift mechanism of FIG. 1;

FIG. 13 is plan view of a portion of another embodiment of the flexible band;

FIG. 14 is a plan view of a portion of the flexible band according to FIG. 13;

FIG. 15 is partial side view of two adjacent flexible bands, accordingly to FIG. 14.

FIGS. 16a and 16b are exploded and plan views of one embodiment of a clamping device for securing the interlocked flexible bands; and

FIG. 17 is a perspective drawing of one embodiment of the interlocked flexible bands secured together by the clamping device of FIGS. 16a and 16b.

### DETAILED DESCRIPTION

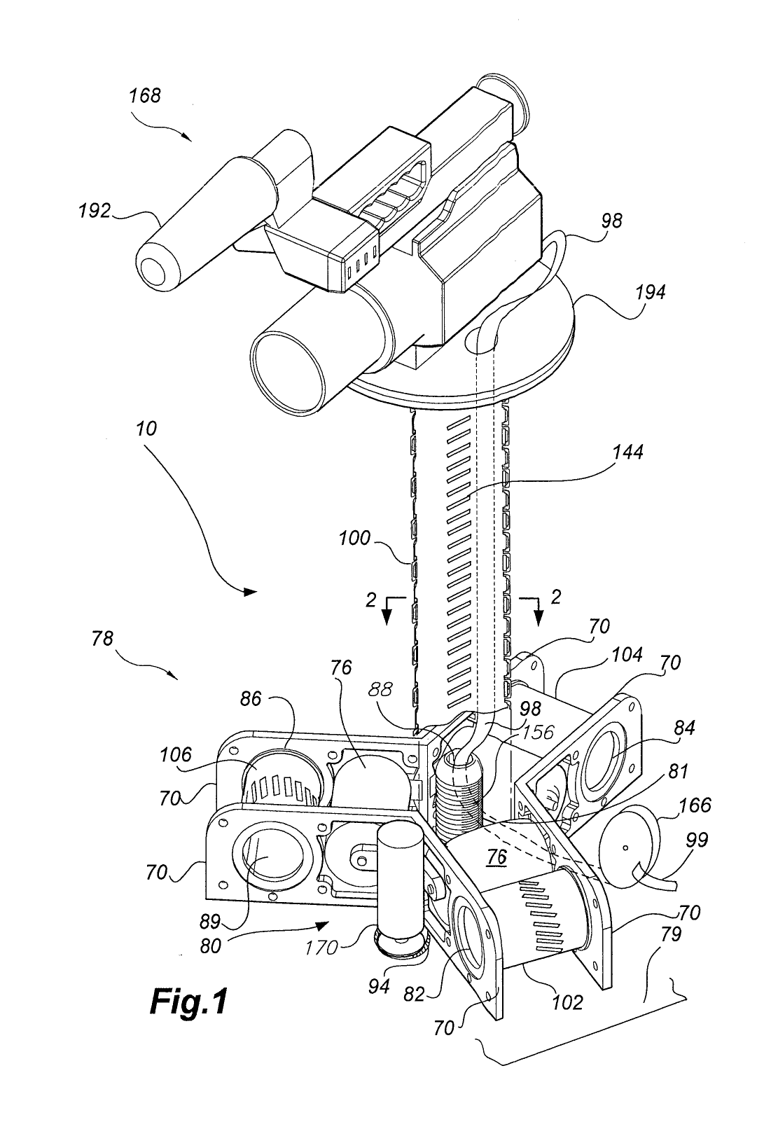

FIG. 1 illustrates one embodiment of an apparatus 10 for raising a retractable mast 100 formed from at least three flat flexible bands 102, 104, 106, each band having a set of tabs and slots disposed along opposite edges of the bands so that the tabs of one band engage the slots of an adjacent band in an interlocking relationship to hold the bands in a rigid formation. In at least one embodiment, the bands are identical to reduce manufacturing and production costs.

The lift mechanism apparatus 10 of FIG. 1 illustrates a camera/sensor package 168 and microphone 182 being elevated by a mast 100 rising from a base unit 78 that further comprises three pairs of spaced apart upright support members 70 preferably mounted on a partially shown support surface 79. Each pair of upright support members 70 respectively supports a spool assembly 82, 84 and 86 rotatably mounted along a horizontal axis.

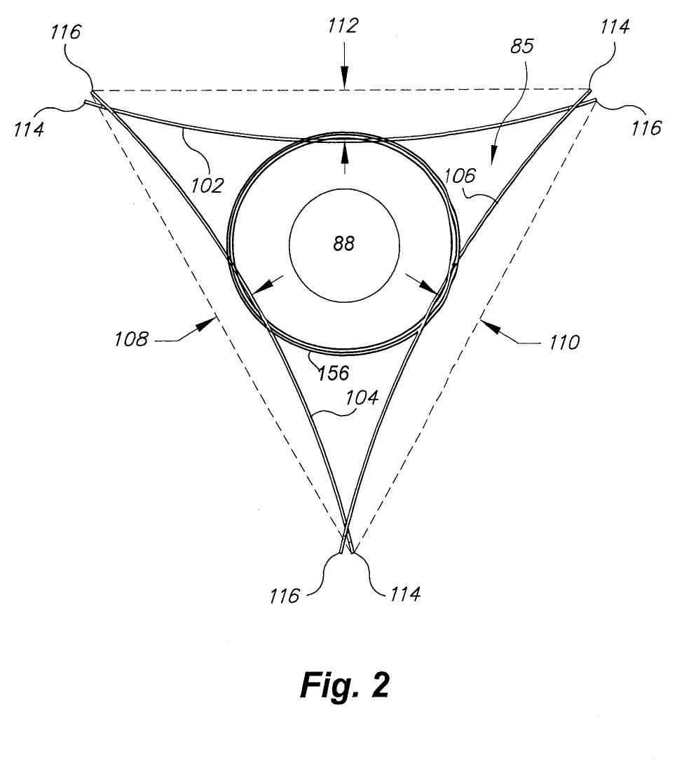

FIG. 1 further illustrates a feed mechanism 80 mounted to the base 78. The feed mechanism 80 is operable to draw together bands 102, 104, and 106 from spools 82, 84, and 86. The bands may pass around rollers 76 that may include a cambered surface 81 operable to press against the body of each band thereby inducing the inward camber 108, 110, 112 illustrated in the mast section view of FIG. 2.

FIG. 1 further depicts wherein locking mechanisms, disposed on opposing edges of the bands, are brought together by action of feed mechanism 80 and a mast having a triangular cross section (see FIG. 2) is formed, raising platform 194 that in at least one embodiment supports camera/sensor package 168.

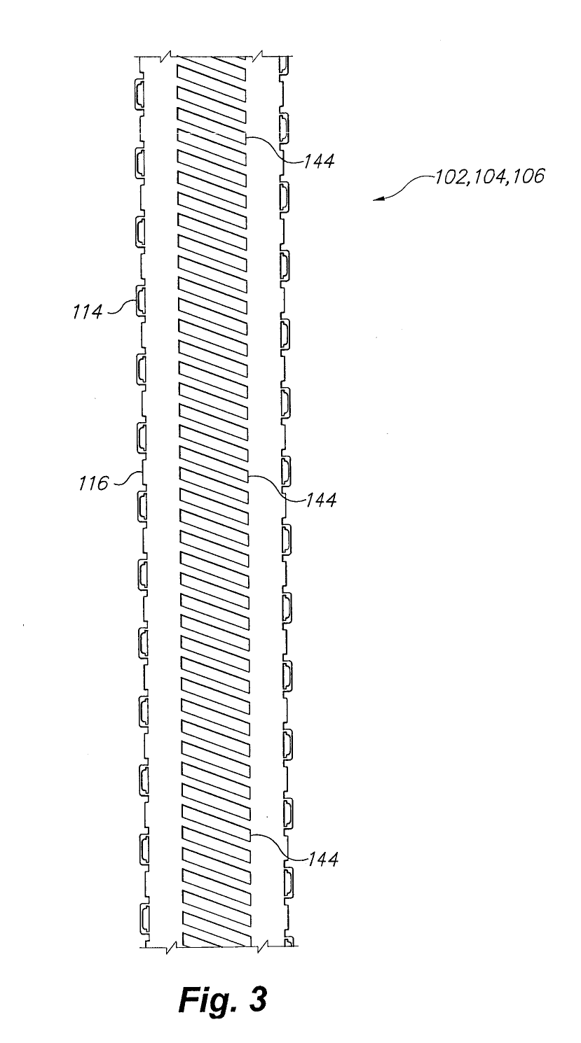

In some embodiments, feed mechanism 80 comprises a threaded shaft 156 rotatably mounted to the base 78 along a substantially vertical axis of rotation, and may be positioned at a center of a triangle formed by the three bands 102, 104 and 106 as best depicted in FIG. 2. Rotated by a motor 170 mounted on the base 78 through a belt drive 94, chain drive or other appropriate linkage arrangement, the threaded shaft 156 comprises a helical thread 92 operable to extend or lower the mast 100 by engaging at least one row of angled drive slots 144 disposed along the length of at least one of bands 102, 104, and 106, as depicted in FIG. 3. In at least the embodiment depicted in FIG. 2, threaded shaft 156 engages all bands to form mast 100. Alternatively, threaded shaft 156 may engage only one or some number of bands less than the number of bands forming the mast 100. For example, in one embodiment, only one band may have angled drive slots 144 and the threaded shaft is configured to engage only the band comprising the angled slots 144.

Furthermore, FIG. 1 illustrates threaded shaft 156 having a coaxial bore 88 operable to allow a multiconductor cable 98 to extend from base 78 to the devices mounted on the platform 194 at the top of the mast 100.

FIG. 2 shows a section view of mast 100 illustrating the inward camber 108, 110, 112 that may result from the flexing of bands 104, 106, 108 respectively, to engage the opposing edges of the bands. Specifically, a tab 116 disposed on an edge of a first band 102 may engage a slot 114 disposed on the edge of an adjacent band 104. The slots 114 and tabs 116 on adjacent bands may be arranged such that at any sectional slice of the mast, a tab 116 disposed on an edge of each band 102, 104, and 106, engages a slot 114 on an adjacent band.

In addition, FIG. 2 illustrates the threaded shaft 156 that in some embodiments may have a sufficient outside diameter to simultaneously engage angled slots 144 (see FIG. 3) spaced along the length of bands 102, 104, and 106. In other embodiments, the threaded shaft 156 may engage a single band 102.

A coaxial bore 88 formed within the threaded shaft 156 may permit at least one signal cable 98 to extend from the base 78 of the apparatus 10, through a passageway 85 formed by bands 102, 104, and 106 along a vertical axis through the length of the mast 100. The at least one signal cable 98 may interconnect at least one device, i.e., camera/sensor 168, mounted on top of the rotatable platform 194 at the top of the mast 100 to components located in the base 78 of the apparatus 10.

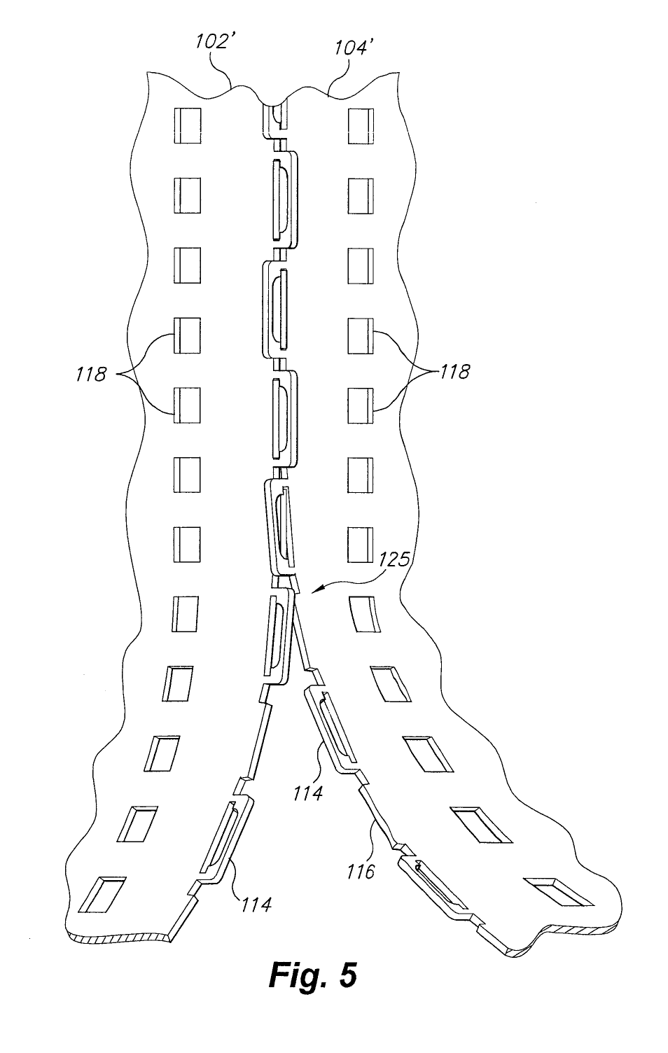

Furthermore, in another embodiment (not shown), the feed mechanism 80 includes a motor mounted within a cavity 89 formed in at least one of spools 82, 84, and 86, operable to drive at least one cambered roller 76 having a gear or sprocket (not shown) having teeth operable to engage the spaced openings 118 (FIG. 5) to drive the bands together, or to separate the bands.

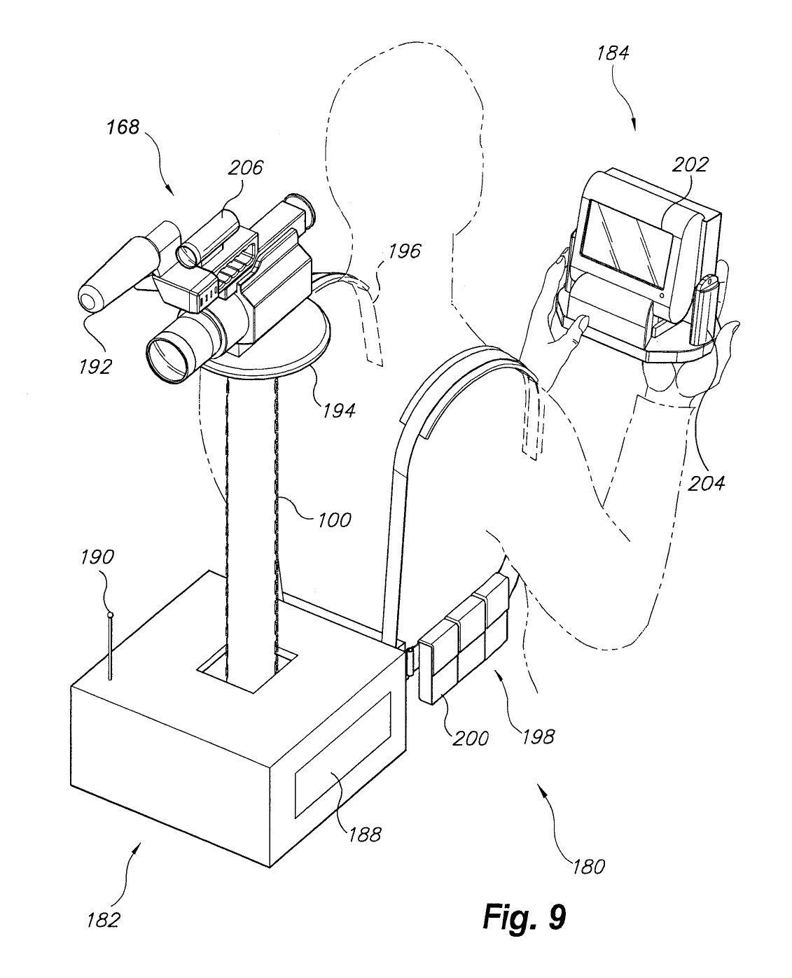

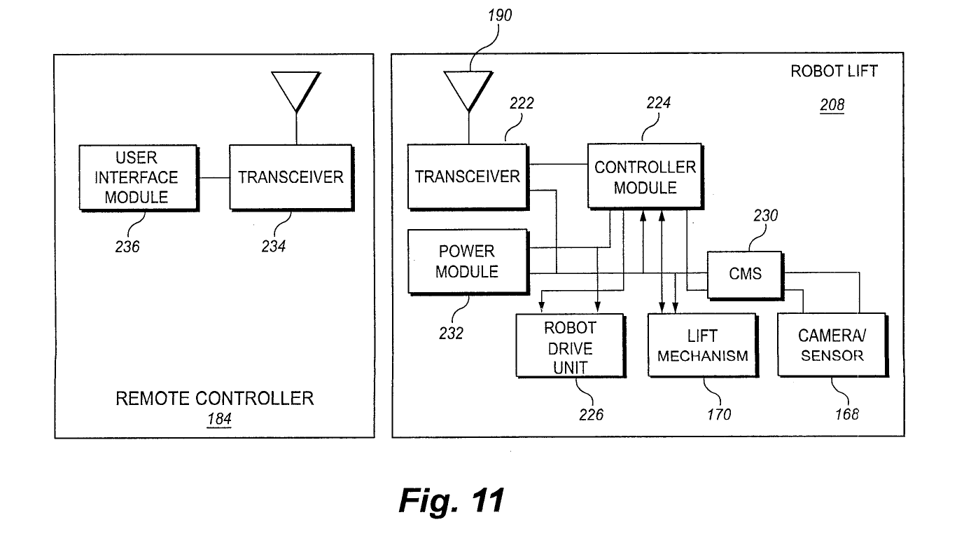

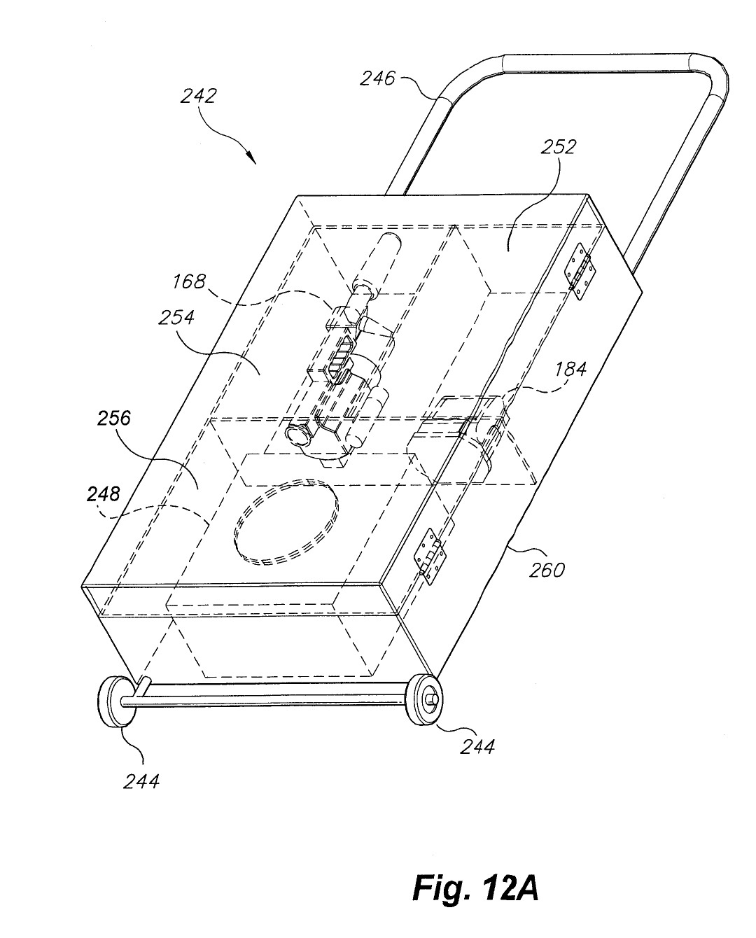

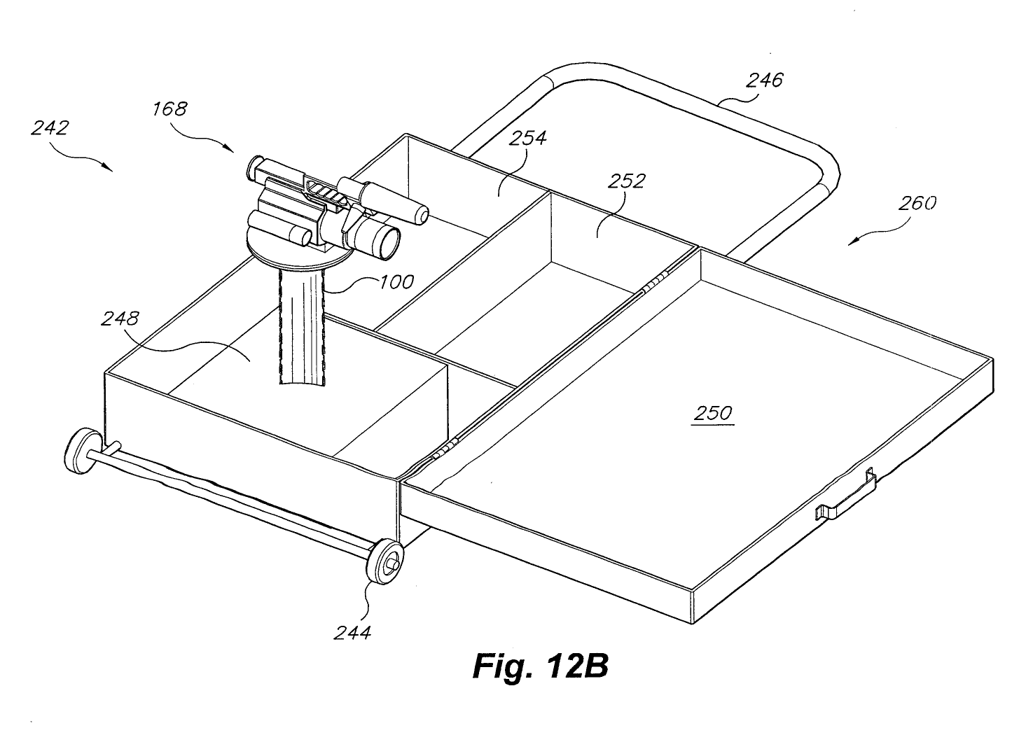

Accordingly, the mast 100 formed is sufficiently rigid for use in environments experiencing external forces such as vibration and wind. Furthermore, in some embodiments, the lift mechanism 10 is included as part of a backpack device 180 carried by an individual, as shown in FIG. 9; as part of a robotic terrain traversing device 208, as shown in FIG. 11; and as part of a suitcase 242, as shown in FIG. 12.

FIG. 3 illustrates a flat flexible band 102 incorporated in the lift mechanism 10 shown in FIG. 1, wherein the helical thread 92 of threaded shaft 88 engages angled drive slots 144 spaced along the length of band 102. Although the threaded shaft 88 may, in some embodiments, engage the angled drive slots 144 of a single band 102, because bands 102, 104, and 106 are interlocked above the connection point 125 (see FIG. 5), the threaded shaft 88, when rotated, operates to draw all of bands 102, 104, and 106 from their respective spools 82, 84, and 86 (see FIG. 1).

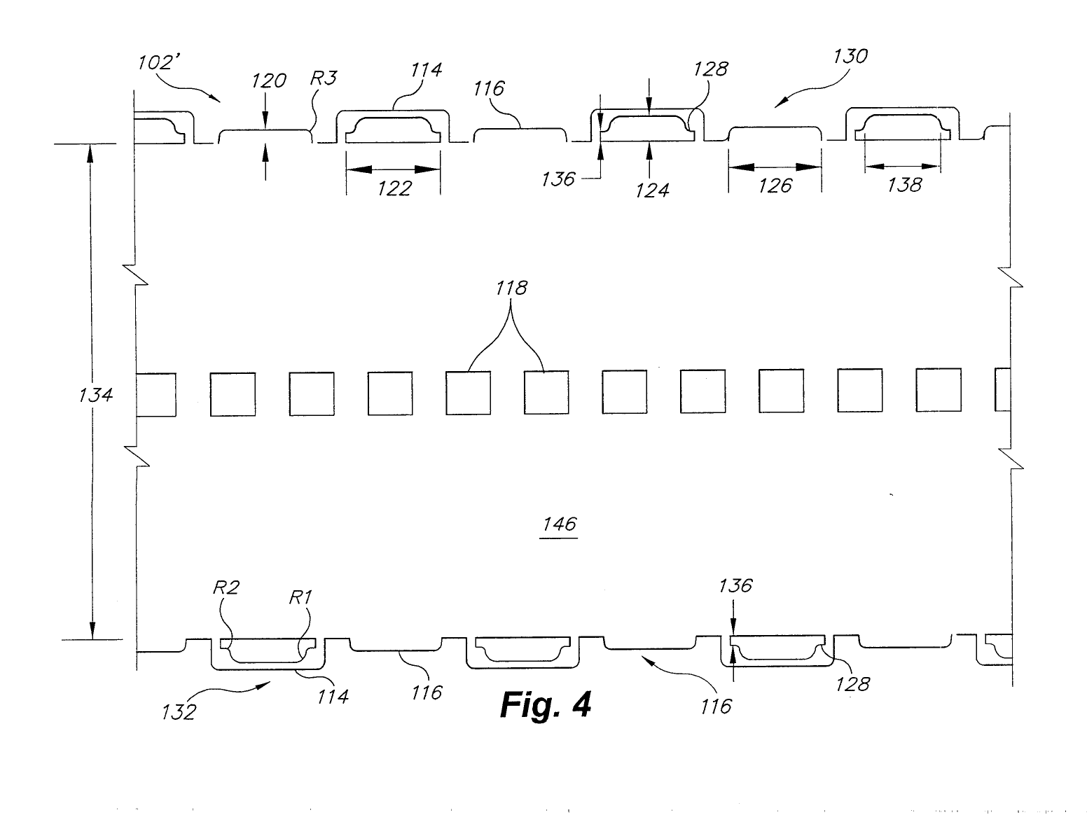

FIGS. 4 is a detailed view of a portion of flexible band 102′ and illustrate one embodiment wherein tabs 116 and slots 114 are alternately disposed along opposite edges 130, 132 of a flat flexible band 102′ separated by a middle body portion 146. The tabs and slots shown on band 102′ are similar to the tabs and slots used in the angled slot embodiment of band 102. The specific configuration of the band 102′ is such that each tab 116 may be disposed opposite a slot 114 on the band 102′ ensuring when using identical bands, a tab 116 on a first band aligns with a slot 114 on a last band when adjacent bands are engaged.

In at least one embodiment, the configuration of tabs 116 and slots 114, disposed along an edge 130 of a band, includes a tab and slot design wherein a tab on one edge 130 is opposite a slot on the opposing edge 132. For example, in some embodiments, a set of alternating tabs 116 and slots 114 encompasses a repeating pattern (not shown) of two tabs followed by two slots along edge 130 for the length of the band 102. On the opposing edge 132, a repeating pattern of two slots followed by two tabs must be formed for the mast to interlock.

FIG. 5 illustrates two bands 102′, 104′, comprising the slot and tab design illustrated in FIG. 4, being drawn together and engaging at the connection point 125. In some embodiments, when in a retracted state, some number of slots and tabs at the top of the mast, where the platform 194 is mounted, remain fully engaged and are permanently fixed together so as to register or align the tabs and slots on adjacent bands, thereby facilitating proper engagement of the bands when forming the mast 100. Facilitating the engagement of each tab and slot is especially important in unattended applications, for example in unmanned sites and lift mechanism operating under remote control.

Each tab 116 is sized to engage a slot 114 of an adjacent band as the bands are drawn together. Once engaged, the outward force created by the camber 108, 110, and 112 operates to maintain the rigidity of the mast 100.

In at least one embodiment, the bands are substantially flat, allowing them to be stored on spools without undue concern that a tab or slot of one layer may engage a tab or slot of a subsequent layer thereby causing the apparatus to bind.

Although the exemplary embodiments illustrated and discussed herein may comprise three bands, other embodiments may employ more bands based upon user specific operational requirements.

In at least one embodiment, each band may be composed of .025 inch thick Type 301, full hard, high yield stainless steel. In other embodiments, the flexible bands may be made of a synthetic material, such as plastic, a flexible ceramic, or a composite material.

Referring back to FIG. 4, in some embodiments, the width 134 of the body 146 of the band may be .820 inches and the tab depth 120 may be .040 inches. Furthermore, the length 126 of each tab 116 may be approximately .248 inches and the outer corners of each tab 116 may be rounded, having a radius R3 of approximate .030 inches, allowing the tab 116 to easily engage the opposing slot 114.

Each slot 114 may be shaped to have a maximum slot length opening 122, i.e., .250 inches, which is slightly larger than the length 126 of a tab 116. Furthermore, in one embodiment, the width 124 of a slot 114, i.e., .060 inches, may be sufficient large to allow the tab 116 and slot 114 to engage at a point of engagement 125, where the bands require maneuvering room to properly engage, as shown in FIG. 5. The outer corners 127 of the slot 114 may have a radius R1 of .030 inches flowing into a rounded shoulder 128 that has a radius R2, i.e., .022 inches, in an opposite direction, allowing the tab 116 to easily engage the slot 114 and slide into position. Once engaged, the tab 116 is held securely in the slot by being pressed against shoulders 128 formed on both ends of the slot 114, the width of the slot 136, being only .100 inch at that point.

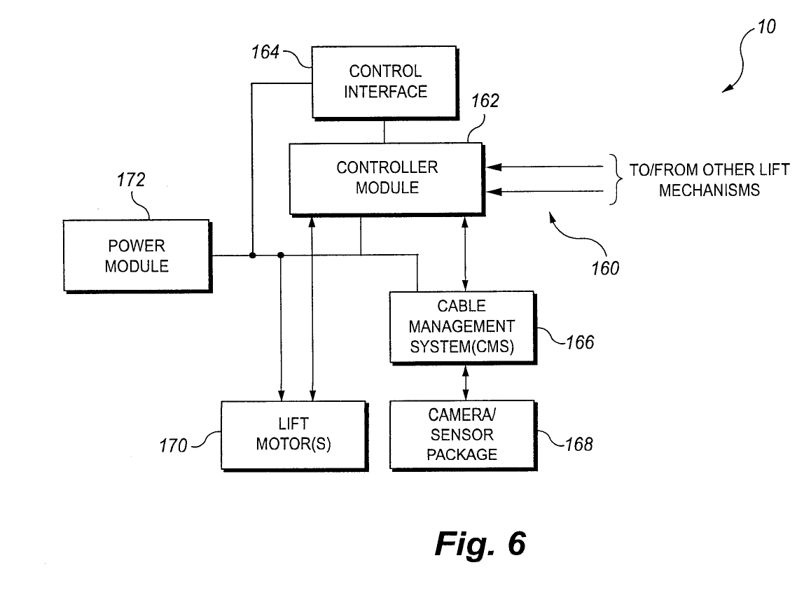

FIG. 6 is a block diagram illustrating the control logic for the lift mechanism 10 of FIG. 1 and comprises a controller module 162 electrically connected to at least one lift motor 170. Electrically connected to the controller module 162 is a control interface 164 operated by a user to raise and lower the mast 100. The control interface 164 may communicate with the controller module 162 via a wired or wireless data link.

The controller module 162 may include an application-specific integrated circuit (“ASIC”), or other chipset, processor, logic circuit, or other data processing device. Controller module 162 may also include memory, which may comprise volatile and nonvolatile memory such as read-only and/or random-access memory (RAM and ROM), EPROM, EEPROM, flash, or any memory common to computer devices.

The controller module 162 may comprise logic that calculates the height of the mast 100 based upon a predetermined formula based upon a run time of the motor 170. An indication of the mast height provided to the user may allow the user to raise the mast 100 to a user determined height, or may allow the controller 162 to raise the mast 100 to a predetermined height by controlling the activation time of the motor 170. Furthermore, the controller module 164 may comprise inputs and outputs 160 that may be connected to other lift mechanisms 10 so as to permit multiple lift mechanism 10 to operate in a master/slave relationship. For example, synchronizing the raising and retracting of a plurality of masts 100 to the same or to different heights based upon predetermined or user selectable inputs may be useful in situations requiring addition support, for example, to form a horizontal surface large enough to support the landing or take-off of an Unmanned Aerial Vehicle (UAV).

Power module 172 may comprise any source of power suitable for use by the lift mechanism 10 and may include AC or DC inputs as well as AC and DC output capability. Non-limiting, the power module 172 may include a power cable to a source of AC power as well as NiMH and Li-ion rechargeable batteries. The power module 172 is operable to deliver required power to the control interface 164, the controller module 162, the lift motor(s) 170, the devices on top of the mast 100, as well as any other devices requiring electric power.

In addition, the lift mechanism 10 may include a cable management system (CMS) 166 (see FIG. 1) that is operable to control the deployment of multi-conductor cable 98, extending from the base 96 of the lift mechanism 10 through the coaxial bore 88 in the threaded shaft 156 and upwards through the center of the mast to electronic equipment, e.g., camera/sensor 168, microphone 192, lights 206, and/or other devices mounted on rotating platform 194.

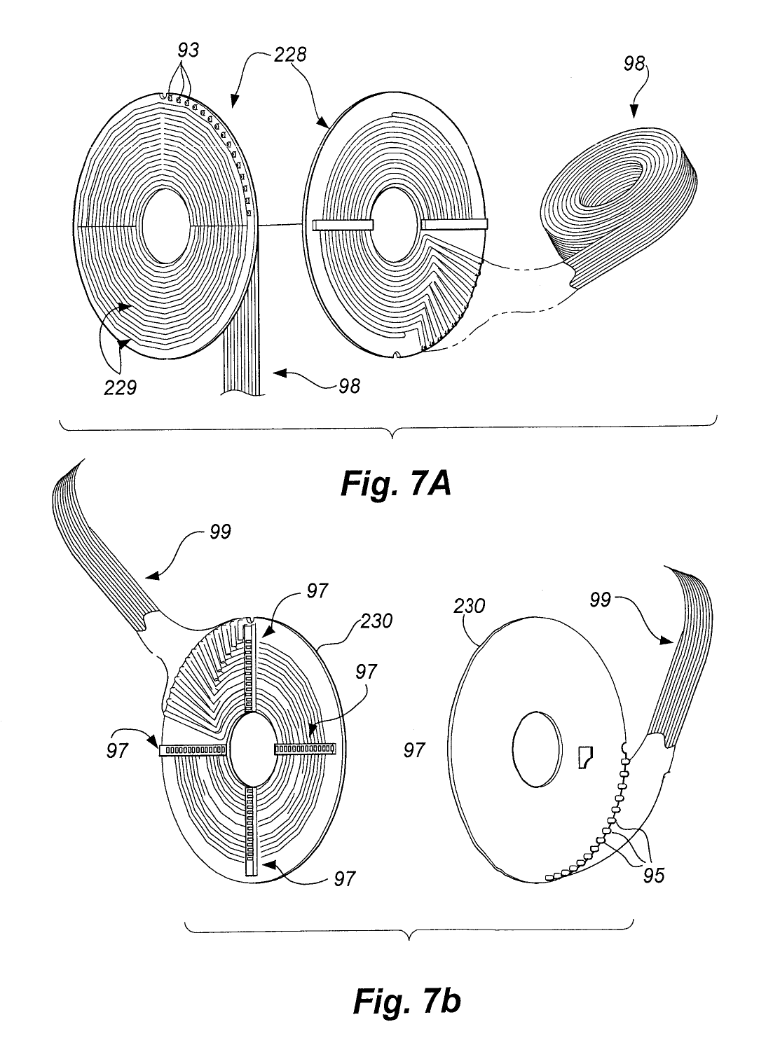

One embodiment of the CMS 166 includes a slip ring mechanism 228, illustrated in FIG. 7. The slip ring 228 is mounted on one side of a rotatably mounted spool (not shown), carrying the multi-conductor cable 98. Electrical leads on one end of the cable 98 may be permanently connected to a plurality of contacts 231 disposed on one side of the slip ring 228. A plurality of concentric conductive tracings 229 disposed on a side of the slip ring 228 opposite from the spooled cable 98, is operable to maintain contact with a plurality of rows 97 of brush contacts disposed on a stationary portion 230 of the CMS 166, as the slip ring 228 rotates. Although only one row of brush contacts is necessary, multiple rows of contacts 97 may be used to guarantee contact.

Further, one end of a second multi-conductor cable 99 is connected to a plurality of terminals 93 on an outer portion of the stationary portion 230. The other end of cable 99 may then be connected to controller module 162, power module 172 and/or other devices supplying signals to or receiving signals from the mast mounted devices.

For example, in some embodiments, the output of the mast supported devices may be fed into recording devices (not shown), the recording devices operable to store the received data for later analysis. Such recording devices include but are not limited to, analog and digital devices that store sound and video data received from a mast mounted microphone 192 and camera 168.

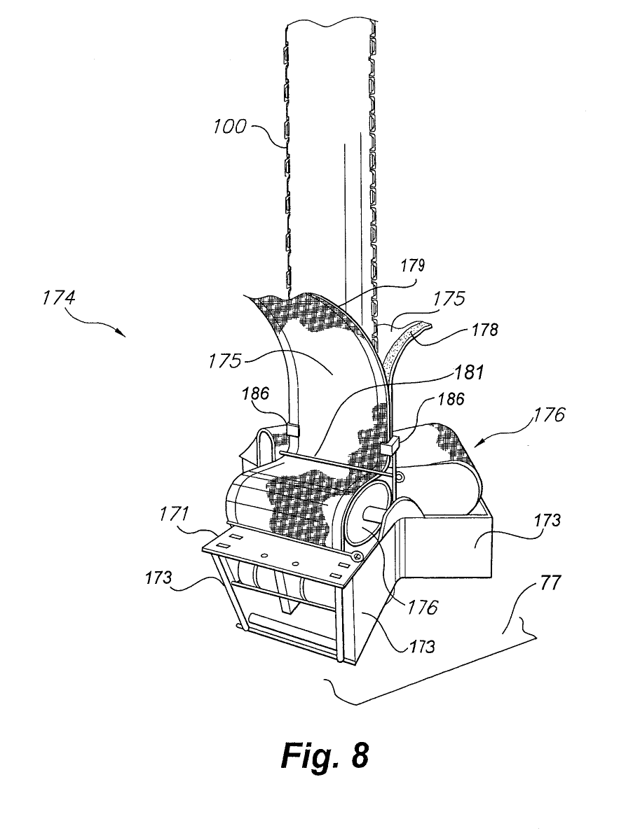

FIG. 8 illustrates one embodiment of an automatically deployable mast shield apparatus 174. In certain environments, the mast 100 may be subject to potentially destructive material which may threaten proper operation of the lift mechanism. For example, rain may pass through openings in the mast 100 and potentially enter the base of the lift mechanism. Furthermore, dust or dirt may clog the slots and freezing rain may lock up the mast 100. Accordingly, a mast shield apparatus 174 that operates to automatically surround the mast 100 as the mast is raised and automatically retracts when the mast is retracted may be beneficial. Furthermore, in some applications, e.g., trade shows, a mast shield apparatus having an esthetically pleasing covering is appropriate.

In some embodiments, mast shield apparatus 174 includes a housing 171 that is mounted over a lift mechanism (not shown). In one embodiment the housing 171 includes three pairs of upright support members 173 mounted on a partially shown support surface 77. Each pair of support members 173 is operable to support a spring powered roller 176 further comprising a spool of mast protecting material 175. In some embodiments, the mast protecting material 175 is made of canvas, a synthetic material, or any suitable material, having a width larger than the flexible bands comprising the underlying mast 100. Furthermore, the top of each band 175 is securely fastened to the top of the mast 100 or may be fastened to the platform 194, as depicted in FIG. 1.

As the mast is raised, the spring loaded spools operate to deploy the shield material 175 while at the same time applying tension to a spring (not shown) disposed within each spool 176. Non-limiting, tensioned rollers are known to those of ordinary skill in the art, and any suitable spooling mechanism may be incorporated.

In one embodiment, a retaining rail 181 is operable to align the shield material 175 in front of the mast 100, at which point a guide mechanism 186 may operates to force the edges 178, 179 of the shield 175 together as the bands 175 are drawn off their respective spool 176. Opposing edges 178, 179 of adjacent bands 175 may employ an attachment mechanism, e.g., Velcro, a plastic or metal zipper arrangement, or other known mechanism, to removably connect the bands 175 together as the mast is raised. As the mast is retracted, the edges 178, 179 disengage after passing through the guide mechanism 186.

FIG. 9 illustrates a backpack embodiment 180 incorporating the lift mechanism 80 of FIG. 1. The lift mechanism may be operated as it is carried by an individual, or may be placed on the ground after being transported to a location. In some embodiments, the exemplary backpack lift 180 includes a lift housing 182, a harness including shoulder straps 196 and belt 198, a hand-held controller 184, and a camera or other sensor device 168 mounted on the rotating platform 194 of the extendable mast 100.

The backpack lift housing 182 may further include a position locator, such as a global positioning system (GPS); communications equipment, and a control/indicator panel 188. The control/indicator panel may be wired to modules within the lift housing and may include controls and indicators pertaining to all backpack lift functions, including, but not limited to battery charging connector terminals, manual controls of backpack functions, an indicator of remaining battery power, and geographical position as determined by the GPS.

Furthermore, an antenna 190 mounted on the backpack lift housing 182 may allow a hand held remote control device 184 to communicate with a transceiver mounted inside the housing 182. The remote control device 184 may comprise a viewing screen 202 and controls 204 operable by the user to control the raising and lowering of the mast as well as the operation of any apparatus, e.g., camera 186, microphone 192, and light 206 mounted on platform 194. In some embodiments, a communications link between the backpack 182 and the remote control unit 184 is wired or wireless and may include, but is not limited to: an infrared network such as an Infrared Data Association (“IrDA”)-based network; ultrasonic, a short-range wireless network; a Bluetooth® technology network; a ZigBee® protocol network; an ultra wide band (“UWB”) protocol network; and a home radio frequency (“HomeRF”) network.

Still referring to the backpack lift of FIG. 9, harness 196 may slip over the shoulders of an individual and fasten in place by means of a buckle or other attachment mechanism commonly used in backpacks. Rechargeable batteries 200 provide electric power for the lift mechanism and may be mounted in the backpack or on the belt 198. The batteries 200 may be NiMH and Li-ion rechargeable batteries or other battery material providing high efficiency power output.

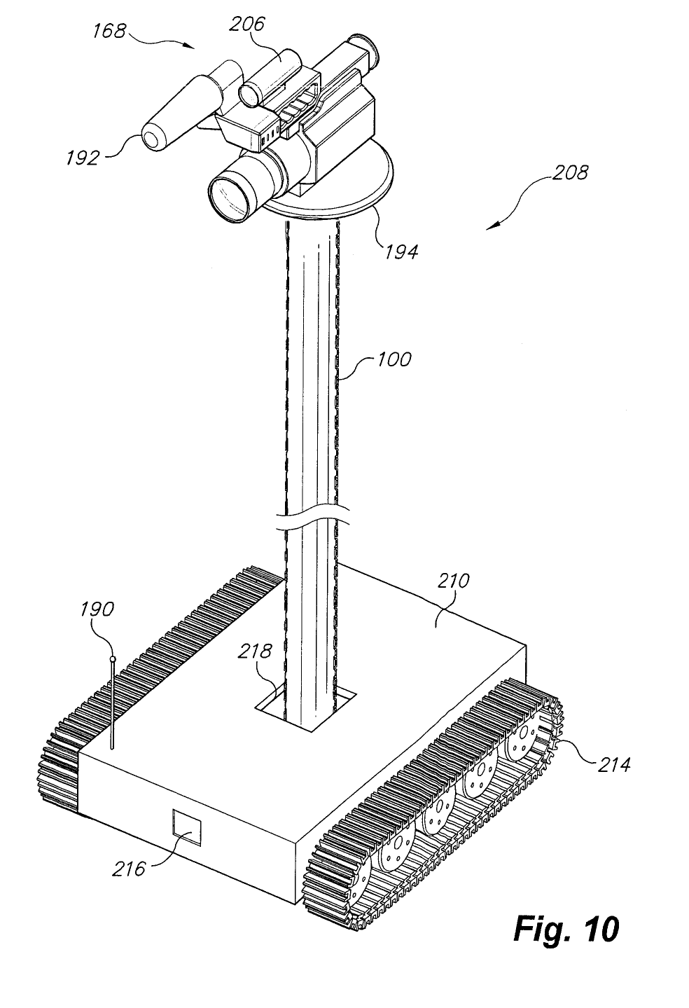

FIG. 10 illustrates a robotic lift apparatus 208 comprising the lift mechanism of FIG. 1 incorporated within a robotic device 210 and FIG. 11 illustrates one embodiment of a block diagram according to the robotic lift mechanism of FIG. 12. Such a robotic lift apparatus 208 may be beneficial to military and law enforcement agencies in providing surveillance at different elevations.

Mounted in a housing 210 equipped with a transport system, e.g., treads 214, a mast 100 may be extended through an opening 218 in the housing 210, raising a camera 168 and/or other devices mounted on a platform 194. A power module 232 mounted within the housing 210 may comprise rechargeable batteries that may be recharged using an external mounted terminal 216. Although treads 214 may be incorporated in the robot lift apparatus 208, robots and robot drive units are known. Accordingly, the actual robot drive unit 226 incorporated may comprise wheels or any other available mechanism.

In some embodiments, the robot 208 includes a controller module 224 operable to control the various operations of the robot, including, but not limited to travel along a surface via a robot drive unit 226, operating lift mechanism 170, and operating the camera/sensor 168 or other device mounted on top of the mast 100. The controller module may further include an application-specific integrated circuit (“ASIC”), or other chipset, processor, logic circuit, or other data processing device. Controller module 224 may also include memory, which may comprise volatile and nonvolatile memory such as read-only and/or random-access memory (RAM and ROM), EPROM, EEPROM, flash, or any memory common to computer devices.

In some embodiments, the robot includes a transceiver 222 allowing the robotic lift mechanism 208 to operate under control of a remote control unit, such as the remote control unit 184, illustrated in FIG. 9. The remote control unit 184 may comprise a transceiver 234 and a user interface module 236, wherein the user interface module 236 may interface with the viewer 202 and controls 204, as shown in FIG. 9. In other embodiments, the user interface module 236 is a desktop device or may incorporate a personal computer (PC) operating software code specifically written to control the robotic lift mechanism 208.

Furthermore, in some embodiments, the robotic lift mechanism 208, under control of a program stored within the controller module, is configured to operate autonomously without user intervention. Such autonomous operations may include traveling to a desired location, extending the retractable mast, activating the camera or other sensor, and transmitting data to a receiving station.

FIGS. 12A and 12B illustrate a portable lift mechanism 242 comprising a lift mechanism 248 incorporated within a suitcase 260 configured to be easily transported by an individual. The suitcase 260 may be made of aluminum, titanium, plastic or other material commonly used to transport electronic apparatus and may include wheels 244 and an extendable handle 246. The suitcase 260 may include several compartments 256, 252, and 254 for storing lift mechanism 248, a remote control unit 184, a camera 168 or other sensor, cables, batteries, and etc. The wheeled suitcase may lay flat on a surface, such that the lift mechanism 248 may operate without being removed from the suitcase, once lid 250 is removed or raised. In some embodiments, the lift mechanism housing 248 is removeably mounted, enabling the lift mechanism 248 to be removed from the suitcase prior to use.

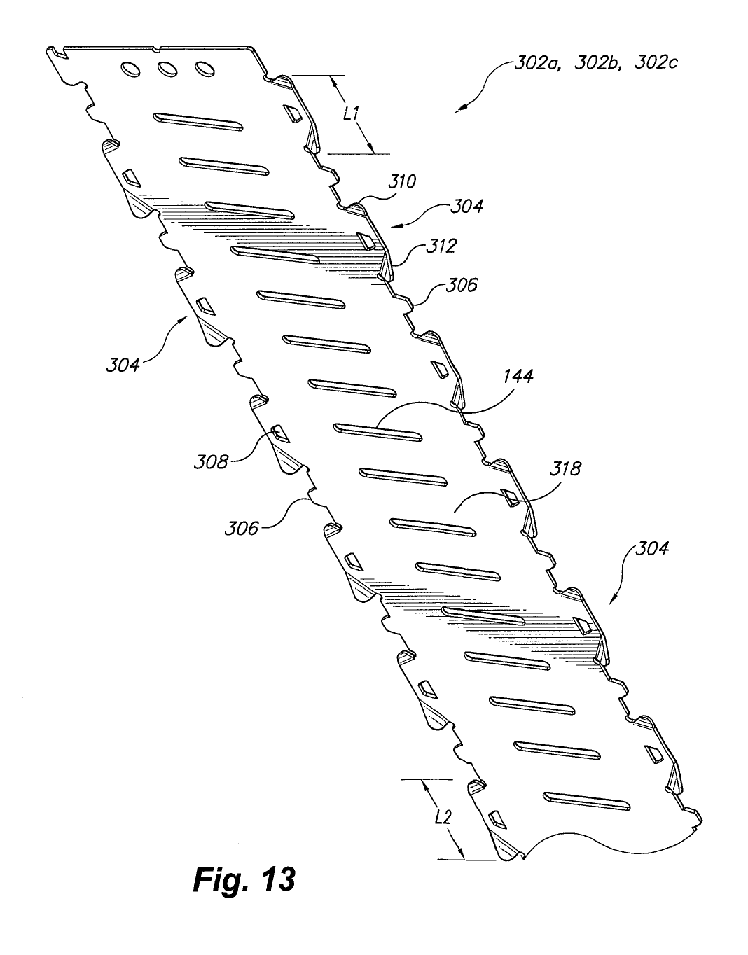

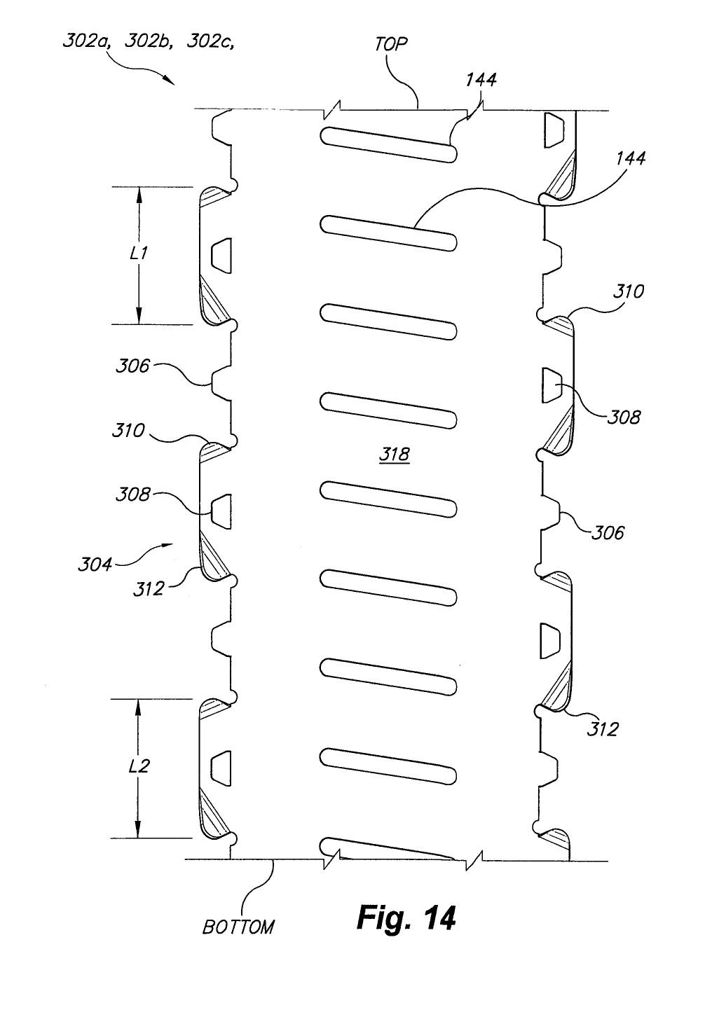

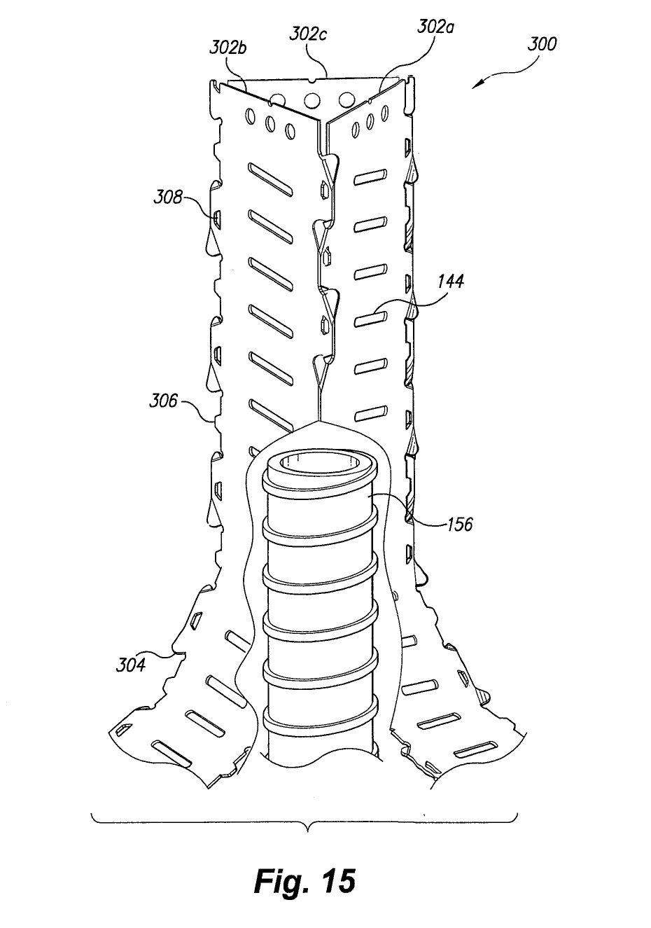

FIGS. 13 and 14 illustrate an alternate embodiment of a flexible band 302a of a set of three flexible bands 302a-c that when engaged, form mast 300 of FIG. 15. Each band 302a-c includes a row of spaced teeth 304 disposed along opposite edges of a flat middle body portion 318. Each tooth 304 includes a crown wherein an upper projecting portion 310 (defined as that portion closest to a top of the mast 300) is angled inward towards a hypothetical vertex of the three interlocked bands, at approximately 40-45 degrees, and a lower projecting portion 312 is angled outward at approximately 20-25 degrees, to facilitate interlocking with an adjacent band. In order to ensure a compact storage of bands 302a-c on respective spool assembly 82, 84, and 86 (see FIG. 1), the length of teeth 304 are progressively longer starting from a bottom tooth 304 having a length L1, that corresponds to the bottom of mast 300, towards the top of the mast 300 where a length L1 of an uppermost tooth 304 is longer than length. Based upon the progressively longer teeth 304, overlapping layers of a band 304 on a spool assembly lay flat on an underlying layer thus allowing for compact storage.

Similar to FIG. 3, the embodiment depicted in FIGS. 13 and 14 illustrate wherein each band includes angled slots 144 spaced along the length of the band. Because the three bands 302a-c join at a specific point on threaded shaft 156 of FIG. 1, the helical thread of shaft 156 requires that the angled slot 144 of each band 302 is offset from the other two bands, and therefore the teeth 304 on one band are differently placed, relative to the angled slot. Accordingly, the three bands 302a-c are a set, each of bands 302a-c being unique and non-interchangeable with the other two bands to ensure that the three bands properly engage.

Still further, mast 300 of FIG. 15 is formed of bands 302 having a dual locking mechanism that includes a slot 308 disposed in each tooth 304 of band 302. A corresponding tab 306 is disposed on an edge of adjacent band 302 between adjacent teeth 304. Not only do the upper ear portion 310 and lower ear portion 312 of a tooth 304 on one band 302 respectively engage lower and upper ear portions of teeth 304 on an adjacent band, but furthermore, tab 306 is configured to engage slot 308 of tooth 304 to more securely lock the three bands 302a-c together. This dual locking mechanism advantageously minimizes twist and provides greater mast stability.

FIG. 15 illustrates wherein mast 300 is formed by bands 302a-c drawn together and upwards by the rotation of threaded shaft 156, the helical thread of shaft 156 acting on the angled slot 144 of each band 302. As depicted, corresponding teeth 304 of adjacent bands 302b and 302c engage and tabs 306 interlock slots 308.

Once engaged, the outward force created by the camber 108, 110, and 112, as depicted in FIG. 2, operates to maintain the rigidity of the mast 300.

In at least one embodiment, bands 302a-c are configured to self wind on spool assemblies 82, 84, and 86 (see FIG. 1) when the mast 300 is lowered. Although the band material may be such to allow self winding without the addition of any mechanical assist, over time, extended usage may result in the bands 302a-c failing to return to a tightly wound state on the spool assembly, whereby the expanded diameter of the wound up band 302 may prevent complete lowering of the mast 300.

To obviate this potential problem, in at least one embodiment, the manufacturing process of bands 302a-c includes the following steps.

Bands 302a-c are laser cut to form a band having the slotted teeth and tabs described above. The bands 302a-c are cut from .015-.032 inch thick Type 301, full hard, high yield stainless steel, which provides extra high strength and is able to resist the external forces that may operate to twist the mast, or cause the bands 302a-c to disengage. The bands are cut so that the direction of the steel bands runs along a lengthwise axis corresponding to a direction when unrolled from a roll of steel used to supply the band material. When cut from steel stock, taking into account the curvature of the supply roll, unrolling and rolling the band on the mast's spool assembly during operation of the mast is facilitated.

Each band 302 is rolled to form a spool of a predetermined inside and outside diameter. The diameters are predetermined based upon the desired height of the mast and the condition that when coiled, teeth 304, including angled upper and lower projections 310 and 312, respectively, are in radial alignment so as to lie flat against an underlying tooth 304. The inner and outer diameters of the wound band 302 are maintained while the wound band 302 is heated for approximately 2-4 hours in an oven preheated to about 650-800 degrees Fahrenheit (preferably 3 hours in an oven preheated to about 700 degrees Fahrenheit), after which time the band 302 is removed and is cooled, e.g., air cooled in at least some embodiments.

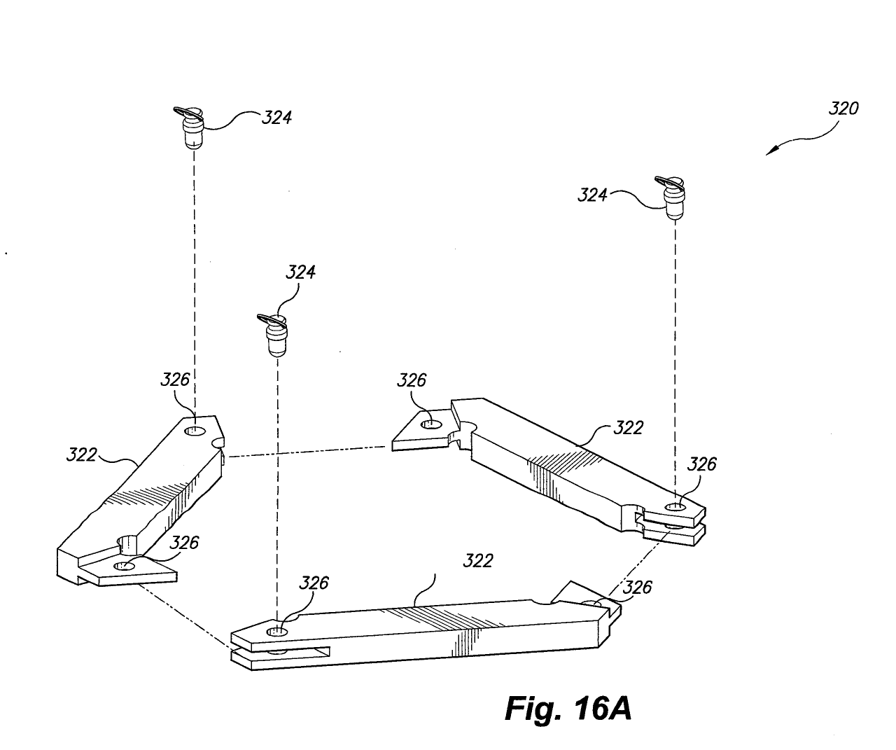

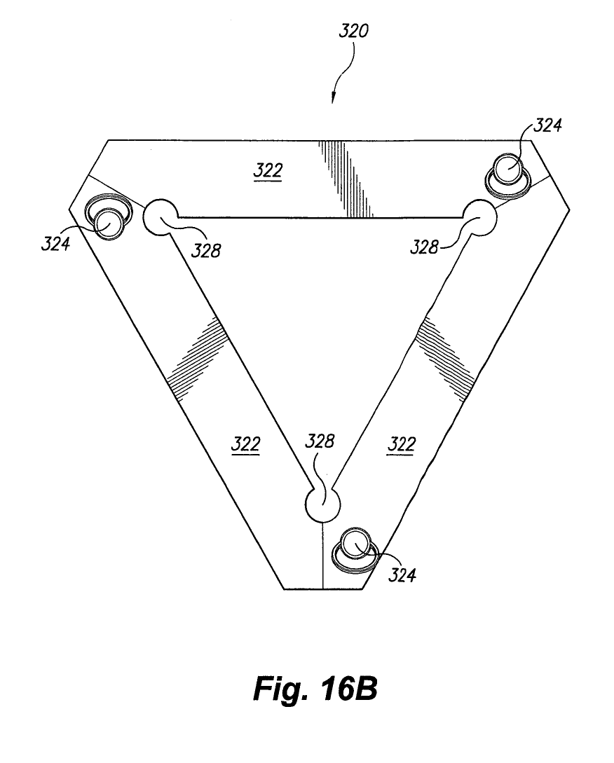

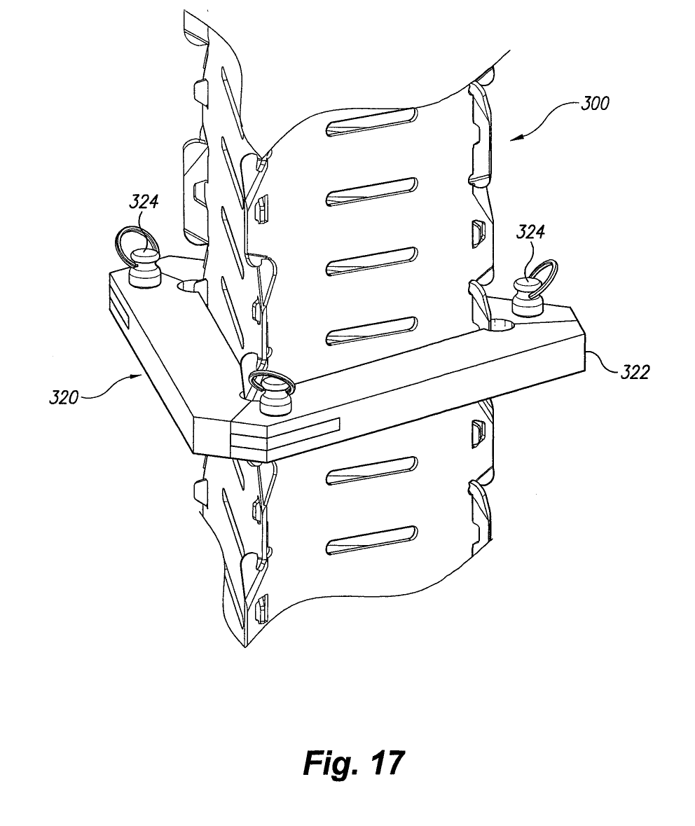

FIGS. 16a, 16b, and 17 depict a clamp 320 that operates to provide additional rigidity to an extended mast 300. In at least one embodiment, the clamp 320 is formed of three legs 322, which are joined together around a three band mast 300 to provide a snug fitting collar around the mast 300 to minimize unintentional unzipping of the mast. The legs 322 are sized to provide minimal space between the clamp 320 and the mast, and clearances 326 are provided at both ends of leg 322 to allow clearance for the interlocking teeth 304.

Depending upon factors that include, but are not limited to the height of the mast 300, the weight of the payload supported by the mast 300, and the external environment of the mast 300, none, one, or more clamps 320 may be removeably attached at predetermined lengthwise spaced positions around the mast 300. In one embodiment a clamp 320 is attached every 5-7 feet of mast, the position identified by markings on at least one band 302 of the mast 300.

In one embodiment, clamp 320 is made of three interlocking metal legs 322 with three pins 324 configured to be inserted into aligned openings 326 in adjacent members 322. When raising the mast 300, clamp 320 is installed around the mast 300 at spaced intervals. The support devices may be quickly removed upon lowering the mast 300. The inner surface of the ends of legs 322 includes a notch 326 to provide clearance for interlocked teeth 304 and tabs 306 on the three vertexes of the mast 300.

Non-limiting, although FIGS. 16a, 16b, and 17 depict one embodiment of support device 320, other embodiments of support device 320 include non-metallic material and may include a one piece construction having hinged or otherwise flexibly connected members 322 having integral locking mechanisms for locking support device 320 snugly around mast 300.

While the foregoing disclosure shows illustrative embodiments, it should be noted that various changes and modifications could be made herein without departing from the scope of the described embodiments as defined by the appended claims. Furthermore, although elements of the described embodiments may be described or claimed in the singular, the plural is contemplated unless limitation to the singular is explicitly stated.

What is claimed is:

1. A method for raising a retractable mast having at least three flexible bands, each band including a left edge portion, a right edge portion, and a body therebetween, wherein each of the right edge portion and the left edge portion of the band has a series of alternating teeth and tabs, each tooth having a slot disposed therein, the method comprising:
drawing at least three flexible bands together at a predetermined point, and
upwardly from said predetermined point, interlocking the at least three flexible bands such that
teeth disposed on the left edge portion of one flexible band engage teeth disposed on the right edge portion of an adjacent flexible band, and
a tab disposed between adjacent teeth on the left edge portion of said one flexible band engages a slot disposed in an opposing tooth on the right edge portion of said adjacent flexible band.

2. The method of claim 1, wherein said interlocking includes interlocking three flexible bands.

3. The method of claim 1, wherein each tooth includes a upper bent portion and a bent lower portion, and wherein the bent upper portion is angled towards an inside of the mast and the bent lower portion is angled towards an outside of the mast.

4. The method of claim 1, wherein said drawing comprises drawing the at least three flexible bands together from within a base, by operation of a drive mechanism within the base.

5. The method of claim 1, further comprising attaching at least one clamping device snugly around the at least three interlocked bands forming the mast at a predetermined spaced interval.

6. The method of claim 1, further comprising raising and retracting a plurality of masts in a synchronized motion.

7. The method of claim 1, further comprising rotating a threaded shaft in an essentially vertical axis, the shaft thread engaging slots disposed on at least one side of the mast.

8. An apparatus for forming a retractable mast formed of at least three interlocked flexible bands, the apparatus comprising:
a support structure;
at least three flexible bands stored within the support structure, each band including:
a left edge portion, a right edge portion, and a body therebetween, wherein each of the right edge portion and the left edge portion of the band has a series of alternating teeth and tabs, each tooth having a slot disposed therein and configured to receive said tab of an interlocking adjacent band; and
a feed mechanism mounted to the support structure and operable to draw together and interlock the at least three flexible bands.

9. The apparatus of claim 8, wherein the at least three flexible bands are three flexible bands.

10. The apparatus of claim 8, wherein each tooth includes an bent upper portion and a lower bent portion, the upper bent portion is angled inwards towards a center of the mast and the lower bent portion is angled outwards towards an outside of the mast.

11. The apparatus of claim 10, wherein the upper bent portion is angled inward towards a hypothetical vertex of the three interlocked bands at approximately 40-45 degrees, and a lower bent portion is angled outward at approximately 20-25 degrees.

12. The apparatus of claim 8, further comprising at least one clamp for retaining a desired shape of the mast, the clamp configured to clamp snugly around the at least three interlocked flexible bands forming the mast at a predetermined spaced interval.

13. The apparatus of claim 12, wherein said clamp includes three rigid members arranged in a triangle configured to be secured around the mast of three flexible bands with minimal space between the clamp and the mast, clearance provided in the rigid members for the interlocking teeth of the bands.

14. The apparatus of claim 8 further comprising a cable management system operable to maintain a continuous electrical connection between at least one electrical device disposed within the housing and at least one other electrical device mounted on a top of the mast while the mast is extended and retracted, the cable management system including a cable disposed within the mast and configured to extend and retract as the mast is extended and retracted.

15. The apparatus of claim 8, wherein the cable management system comprises a slip ring operable to maintain at least 15 continuous electrical connections.

16. The apparatus of claim 8, further comprises a control unit operable by a user to control the extending and retracting of the mast.

17. A method of manufacturing a flexible band for a retractable mast, the method comprising:
laser cutting a length of band from .015-.032 inch thick Type 301, full hard, high yield stainless steel to form a band having a row of spaced teeth disposed along opposite lengthwise edges of a flat middle body portion;
coiling the band to form a spool;
maintaining a shape of the formed spool while the coiled band is heated for approximately 2-4 hours in an oven preheated from about 650 - 800 degrees Fahrenheit; and
removing and cooling the coiled band.
